(19) United States
(12) Patent Application Publication
(10) Pub. No.: US 2026/0071681 A1
(43) Pub. Date: Mar. 12, 2026

(54) METHOD FOR MAKING A SEAL FOR METAL-TO-METAL PRESS-FIT JOINTS

(71) Applicant: Freudenberg-NOK General Partnership, Plymouth, MI (US)

(72) Inventors: Chad D. BAUER, Fenton, MI (US); Andrew ESPINOZA, Cumming, GA (US); Darin BATTLES, Dahlonega, GA (US)

(21) Appl. No.: 18/882,887

(22) Filed: Sep. 12, 2024

(51) Int. Cl. F16J 15/328

(52) U.S. Cl. CPC F16J 15/328

(57) ABSTRACT

A method for making a press-fit seal which inhibits leak paths between a press-fit joint. An annular metal insert is formed with a cylindrical outer surface. A sealing element is molded to the annular metal insert that includes a main seal lip configured to interface with an outside cylindrical surface of a shaft or hub. Coating material is applied to the cylindrical outer surface of the annular metal insert by either adhering the material to the surface with adhesive or heat shrinking the material to fix to the surface of the annular metal insert to fill-in potential deformities of the cylindrical outer surface of the annular metal insert that could cause a leak path.

### FIELD

The present disclosure relates to a method for applying sealing material for metal-to-metal press-fit joints.

### BACKGROUND

This section provides background information related to the present disclosure which is not necessarily prior art.

Current seals use a latex coating applied to a metal surface of the seal insert. The intent of this coating is to fill any minor imperfections that might form a leak path at the metal-to-metal joint between the insert and the metal housing bore. However, the painting process used to apply latex paint to the metal insert is cumbersome and time consuming requiring application and drying cycle times. Accordingly, it is desirable to reduce the time necessary to provide an adequate coating to the seal insert. In addition, the painting process creates environmental hazards with paint spray and fumes. Therefore, it is desirable to reduce the negative environmental impact of the current process and to provide a more uniform application of the sealant.

### SUMMARY

This section provides a general summary of the disclosure, and is not a comprehensive disclosure of its full scope or all of its features.

According to an aspect of the present disclosure, a method for making a press-fit seal incudes forming an insert into an annular metal insert, molding at least one seal element to the annular metal insert, and forming a coating on the annular metal insert that includes a length of material wrapped around the annular metal insert.

According to another aspect the coating is made from a monomer or polymer material.

According to another aspect the annular metal insert is made from metal.

According to another aspect the length of material is adhered to the annular metal insert.

According to another aspect the length of material is dispensed to the annular metal insert from a roll.

According to another aspect the coating is formed in a heat shrink ring.

According to another aspect the heat shrink ring is shrank onto the annular metal insert.

According to a further aspect, a method for making a press-fit seal includes forming an insert into an annular metal insert, molding at least one seal elements to the annular metal insert, adhering a length of material to an outer peripheral surface of the annular metal insert, and dispensing the length of material to the outer peripheral surface of the annular metal insert from a roll.

According to another aspect the annular metal insert is made of metal.

According to another aspect the length of material is made from a monomer or polymer material.

According to another aspect the length of material has a side which interfaces with the outer peripheral surface of the annular metal insert and another side.

According to another aspect the length of the material has adhesive on the side which interfaces with the outer peripheral surface of the annular metal insert.

According to another aspect the length of material is transferred from the roll with a carrier.

According to another aspect the length of material is dispensed from the roll without a carrier.

According to a further aspect, a method for making a press-fit seal includes forming an insert into an annular metal insert, molding at least seal element to the annular metal insert, and fixing a heat shrink ring of material to the annular metal insert.

According to another aspect the annular metal insert is made of metal.

According to another aspect the heat shrink ring is made from a monomer or polymer material.

According to another aspect the heat shrink ring surrounds an outer peripheral surface of the annular metal insert.

According to another aspect the heat shrink ring and the annular metal insert are exposed to a heating element.

According to another aspect the heat shrink ring reduces in size around the annular metal insert when exposed to the heating element.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a cross-sectional view of an example press-fit seal shown in an assembled condition according to the principles of the present disclosure;

FIG. 2 is a cross-sectional view of the press-fit seal shown in FIG. 1;

FIG. 3 is a schematic view of the press-fit seal with a strip of material applied to the metal insert from a roll; and

FIG. 4 is a schematic view of the press-fit seal with a ring of heat shrink material being applied to the metal insert.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

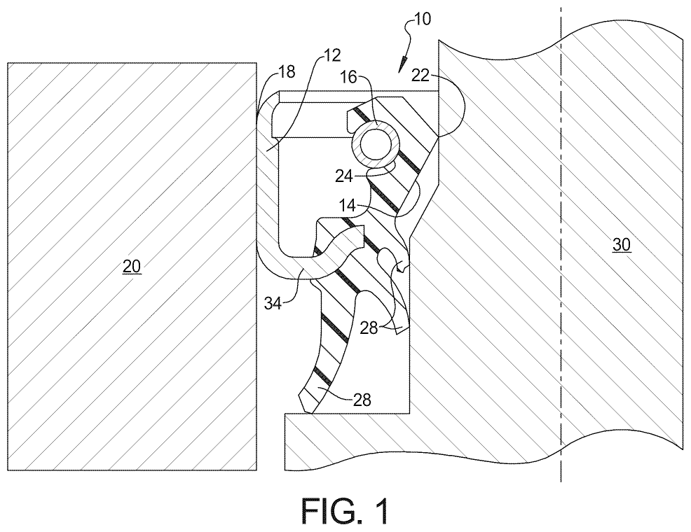

Referring to FIG. 1, a seal 10 is shown installed between a shaft 30 and a housing 20. The seal 10 may include an annular metal insert 12 and a seal portion 14 molded to the metal insert 12. The seal 10 can be press-fit within a bore of the housing 20. The sealing portion 14 can be made of rubber or other sealing material and includes a main seal lip 22 which can seal against the shaft 30.

With continued reference to FIG. 1, the inner seal portion 14 can include a recess 24 for receiving a garter spring 16. The garter spring 16 can compress the main seal lip 22 against the shaft/hub 30. The seal portion 14 is molded to a radially inwardly extending flange portion 34 of the annular metal insert 12. The seal portion 14 can also include at least one dust lip 28 (three are shown) extending away from the main seal lip 22 to prevent particulates and foreign debris from affecting the sealing around the shaft/hub 30.

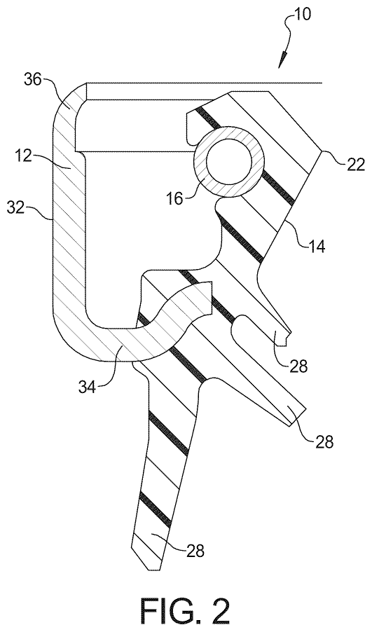

Referring to FIG. 2, the annular metal insert 12 can include a cylindrical outer portion 32 with the flange portion 34 extending from one end and a radial portion 36 which extends from a second end of the cylindrical outer portion 32. The cylindrical outer portion 32 of the annular metal insert 12 is configured to be press-fit into the bore of the housing 20. The radial portion 36 arches toward the sealing portion 14 and has reduced material thickness which reduces the cylindrical outer portion 32 thickness which can allow bending of the annular metal insert 12 resulting in a proper interfacing between the annular metal insert 12 and the bore 20 to form the joint 18.

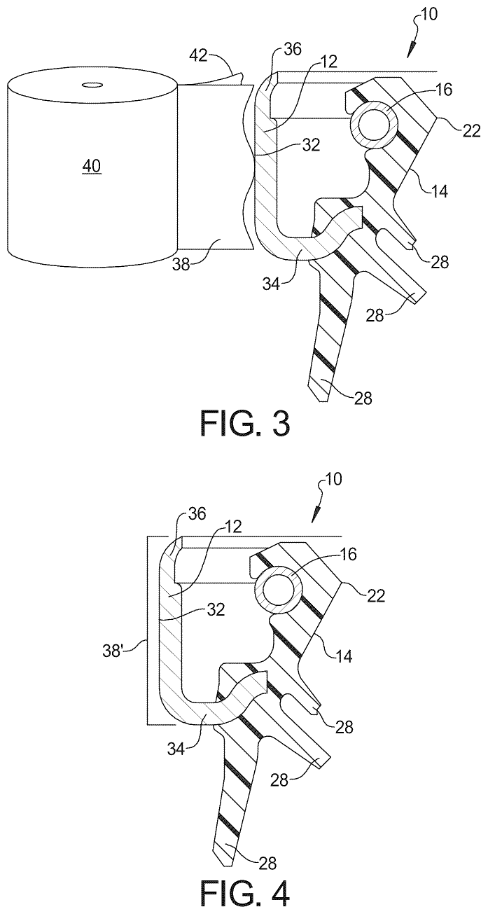

Referring to FIGS. 3 and 4, the cylindrical outer portion 32 of the annular metal insert 12 that interfaces with the bore of the housing 20 has a coating material 38 applied to seal potential leak paths between the metal-to-metal press-fit joint 18. As shown in FIG. 3, the coating material 38 can be made from a monomer or polymer material and can be dispensed from a roll 40. The roll 40 can have a base layer/backing42 for the material to adhere to or dispense the coating material 38 where the coating material has its own adhesive applied. The coating material 38 can optionally be cut to a specific length that is equal to the circumference of the annular metal insert 12 diameter to abate overlapping of the coating material 38 upon itself.

The coating material 38′, can be fixed to the annular metal insert 12 by a heat shrink process as shown in FIG. 4, and can be made from heat shrinkable material such as a monomer or polymer and can be placed around the cylindrical outer portion 32 of the annular metal insert 12 as an annular ring and exposed to a heating element to shrink the coating material 38 to the outer surface of the annular metal insert 12.

The seal 10 including the annular metal insert 12, the inner seal portion 14, and the optional garter spring 16 and coating material 38, 38′ work in tandem to remove leak paths, keep out debris, and to encapsulate fluid in a system. When the seal 10 is press-fit into the bore 20, the annular metal insert 12 is compressed by the bore 20 and the inner seal portion 16 engages with the shaft 30. The coating material 38 is used to ensure any potential imperfection on the annular metal insert 12 cylindrical outer portion 32 does not create a leak path when the annular metal insert 12 is press-fit into the bore 20 to create the joint 18.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method for making a press-fit seal, comprising the steps of:
forming an annular metal insert;
molding at least one seal element to the annular metal insert; and
dispensing a length of a material from a roll and adhering the length of the material around the annular metal insert.

2. The method according to claim 1, wherein the length of the material is made from a monomer or polymer material.

3. (canceled)

4. The method according to claim 1, wherein the length of the material is adhered to the annular metal insert.

5. (canceled)

6. (canceled)

7. (canceled)

8. A method for making a press-fit seal, comprising the steps of:
forming an annular metal insert;
molding at least one seal element to the annular metal insert;
dispensing a length of material from a roll; and
adhering the length of material onto an outer peripheral surface of the annular metal insert.

9. (canceled)

10. The method according to claim 8, wherein the length of material is made of a monomer or polymer material.

11. The method according to claim 8, wherein the length of material has a side which interfaces with the outer peripheral surface of the annular metal insert.

12. The method according to claim 11, wherein the length of the material has adhesive on the side which interfaces with the outer peripheral surface of the annular metal insert.

13. The method according to claim 8, wherein the length of material is transferred from the roll with a backing.

14. The method according to claim 8, wherein the length of material is dispensed from the roll without a carrier.

15. A method for making a press-fit seal, comprising the steps of:
forming an annular metal insert;
molding at least one seal element to the annular metal insert; and
fixing a heat shrink ring of a material to the annular metal insert.

16. (canceled)

17. The method according to claim 15, wherein the material of the heat shrink ring is one of a monomer or polymer material.

18. The method according to claim 15, wherein the heat shrink ring surrounds an outer peripheral surface of the annular metal insert.

19. The method according to claim 18, wherein the heat shrink ring and the annular metal insert are heated.

20. The method according to claim 19, wherein the heat shrink ring reduces in size around the annular metal insert when heated.
